(19) United States
(12) Patent Application Publication
(10) Pub. No.: US 2003/0221759 A1
(43) Pub. Date: Dec. 4, 2003

(54) Multi-piece rim for pneumatic tire

(75) Inventor: Christopher James Weston, Coquitlam (CA)

Correspondence Address: Elbie R. de Kock, Two Bentall Centre, Suite 700, 555 Burrard Street, Vancouver, BC, CA

(73) Assignee: Rimex Wheel Manufacturing Ltd.

(21) Appl. No.: 10/157,140

(22) Filed: May 30, 2002

(51) Int. Cl. B60B 25/00

(52) U.S. Cl. 152/410

(57) ABSTRACT

A multi-piece rim assembly for a pneumatic tire comprises a substantially cylindrical rim base with opposite annular ends and a pair of side flanges at the opposite annular ends. At least one of the flanges is shrink-fitted in position, thereby to counteract relative rotation between the flange and the rim base. Preferably both of the side flanges are shrink-fitted in position. A method of manufacturing a multi-piece rim assembly is also provided which comprises the step of shrink-fitting one or both of the flanges in position.

### FIELD OF THE INVENTION

This invention relates to a multi-piece rim assembly for mounting a pneumatic tire thereon, such as for use on a large industrial vehicle.

### BACKGROUND OF THE INVENTION

A rim assembly mounting a tire on a large vehicle is normally formed from a plurality of separate pieces. Typically, the assembly is a five piece structure comprising a cylindrical rim base having opposed annular edges, a first side flange located against one of the annular edges of the rim base, a second side flange located at the other annular edge of the rim base, an annular bead seat band located between the rim base and the second side flange and a lock ring which engages with a lock ring recess in the rim base to lock the pieces together. The pneumatic tire is held in position between the side flanges. The loose side flanges are held in place against the annular edges of the rim base by the air pressure of the tire.

A problem that arises is that the side flanges tend to rotate relative to the rim base during rapid acceleration or deceleration due to torque input from the tire. This results in mechanical damage to the rim base and side flanges.

### SUMMARY OF THE INVENTION

According to the invention there is provided a multi-piece rim assembly for a pneumatic tire comprising a substantially cylindrical rim base with opposite annular ends and a pair of side flanges at the opposite annular ends, wherein at least one of the flanges is shrink-fitted in position, thereby to counteract relative rotation between the flange and the rim base. Preferably both of the side flanges are shrink-fitted in position.

Also according to the invention there is provided a multi-piece rim assembly for a pneumatic tire, comprising a substantially cylindrical rim base with opposite annular ends; a first side flange located against one of the annular edges; a second side flange located at the other annular edge; and an annular bead seat band located between the second side flange and the rim base, wherein the second side flange is shrink-fitted around the bead seat band, thereby to counteract relative rotational movement between the second flange and the bead seat band. In a preferred embodiment, the first side flange is also shrink-fitted onto the rim base, thereby to counteract relative rotational movement between the first side flange and the rim base.

Also according to the invention there is provided a multi-piece rim assembly for a pneumatic tire, comprising a substantially cylindrical rim base having an annular end and a side flange located against the annular edge for containment of a tire mounted on the rim assembly, wherein the side flange is shrink-fitted onto the rim base, thereby to counteract relative rotational movement between the side flange and the rim base.

Further according to the invention there is provided a method of manufacturing a multi-piece rim assembly for a pneumatic tire, which rim assembly comprises a substantially cylindrical rim base with opposite annular ends and a pair of side flanges at the opposite annular ends, comprising the step of shrink-fitting at least one of the side flanges in position, thereby to counteract relative rotation between the flange and the rim base.

Also according to the invention there is provided a method of manufacturing a multi-piece rim assembly for a pneumatic tire, which rim assembly comprises a substantially cylindrical rim base with opposite annular ends; a first side flange located against one of the annular edges; a second side flange located at the other annular edge; and an annular bead seat band located between the second side flange and the rim base, comprising the step shrink-fitting the second flange around the bead seat band, thereby to counteract relative rotation movement between the second flange and the bead seat band. Preferably, the method further comprises the step of shrink-fitting the first side flange onto the rim base, thereby to counteract relative rotational movement between the first side flange and the rim base.

Also according to the invention there is provided a method of manufacturing a multi-piece rim assembly for a pneumatic tire, which rim assembly comprises a substantially cylindrical rim base having an annular end and a side flange located against the annular edge for containment of a tire mounted on the rim assembly, comprising the step of shrink fitting the side flange onto the rim base, thereby to counteract relative rotational movement between the side flange and the rim base.

Further objects and advantages of the invention will become apparent from the description of preferred embodiments of the invention below.

### BRIEF DESCRIPTION OF THE DRAWINGS

FIG. 1 shows a radial cross-section of a five piece rim assembly for a large industrial vehicle;

FIG. 2 is a cross-section similar to FIG. 1 but with part of the rim base omitted; and

FIG. 3 is a partial three-dimensional view of the parts shown in FIG. 2.

### DETAILED DESCRIPTION OF THE PREFERRED EMBODIMENTS

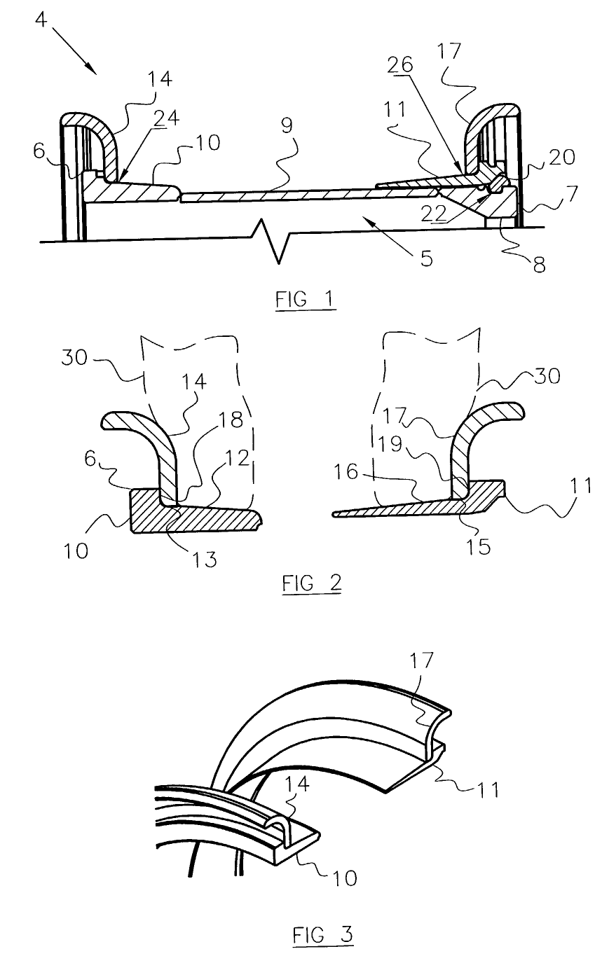

In FIG. 1, reference numeral 4 generally indicates a five piece rim assembly comprising a cylindrical rim base 5 having opposed annular edges 6 and 7; a first side flange 14 located against the annular edge 6; a second side flange 17 located at the other annular edge 7; an annular bead seat band 11; and a lock ring 20 which engages with a lock ring recess 22 locking the assembly together.

As shown, the bead seat band 11 is inserted between the second side flange 17 and the rim base 5.

The rim base 5 is conveniently manufactured from three separate parts, i.e. an annular rim back section 10, an annular gutter section 8 and a cylindrical centre band or centre section 9, to form a unitary structure.

In FIGS. 2 and 3, the disposition of the side flanges 14 and 17 with respect to the rim back section 10 and seat band 11, respectively, is shown. A portion of a tire 30 that is mounted on the rim assembly 5 is shown in broken lines in FIG. 2.

In conventional rim assemblies, only friction force at interfaces 18, 19 (FIG. 2) opposes the torque input form the tire 30 on the side flanges 14, 17. As a result, the flanges 14, 17 can rotate relative to the rim base 5 causing fretting damage to the interfaces 18, 19.

According to the present invention, either one or both of the side flanges 14, 17 are manufactured having an inside diameter slightly less than the outside diameter of corresponding part of the rim base 5 or bead seat band 11 where the respective side flange 14, 17 will be located. These outside diameters are indicated at 24 and 26 in FIG. 1.

Prior to assembly, the flanges 14, 17 are heated. Due to thermal expansion the inside diameters of the flanges 14, 17 increase so that they can fit around the outside diameters 24 and 26. As the flanges 14, 17 cool, they contract to form a tight shrink fit around the rim base 5. In the resulting rim assembly 4, the interference shrink fit counteracts rotation or spinning of the side flanges 14, 17 relative to the rim base 5. In order to achieve a proper shrink fit, the inside diameters of the flanges 14 and 17 and the outside diameters 24 and 26 are machined for an accurate fit.

Either one or both of the flanges 14, 17 can be shrink fitted in this fashion.

Although certain preferred embodiments of the present invention have been shown and described in detail, it should be understood that various changes and modifications may be made therein without departing from the scope of the appended claims.

We claim:

1. A multi-piece rim assembly for a pneumatic tire comprising a substantially cylindrical rim base with opposite annular ends and a pair of side flanges at the opposite annular ends, wherein at least one of the flanges is shrink-fitted in position, thereby to counteract relative rotation between the flange and the rim base.

2. The multi-piece rim assembly according to claim 1, wherein both of the side flanges are shrink-fitted in position.

3. A multi-piece rim assembly for a pneumatic tire, comprising:
a substantially cylindrical rim base with opposite annular ends;
a first side flange located against one of the annular edges;
a second side flange located at the other annular edge; and
an annular bead seat band located between the second side flange and the rim base, wherein the second side flange is shrink-fitted around the bead seat band, thereby to counteract relative rotational movement between the second flange and the bead seat band.

4. The multi-piece rim assembly according to claim 3, wherein the first side flange is shrink-fitted onto the rim base, thereby to counteract relative rotational movement between the first side flange and the rim base.

5. The multi-piece rim assembly according to claim 4, wherein the rim base is provided with a lock ring recess on one of the annular ends and further comprising a lock ring which engages with the lock ring recess for locking the assembly together.

6. A multi-piece rim assembly for a pneumatic tire, comprising:
a substantially cylindrical rim base with opposite annular ends;
a first side flange located against one of the annular edges;
a second side flange located at the other annular edge; and
an annular bead seat band located between the second side flange and the rim base, wherein the first side flange is shrink-fitted onto the rim base, thereby to counteract relative rotational movement between the first side flange and the rim base.

7. A multi-piece rim assembly for a pneumatic tire, comprising:
a substantially cylindrical rim base having an annular end and a side flange located against the annular edge for containment of a tire mounted on the rim assembly, wherein the side flange is shrink-fitted onto the rim base, thereby to counteract relative rotational movement between the side flange and the rim base.

8. A method of manufacturing a multi-piece rim assembly for a pneumatic tire, which rim assembly comprises a substantially cylindrical rim base with opposite annular ends and a pair of side flanges at the opposite annular ends, comprising the step of shrink-fitting at least one of the side flanges in position, thereby to counteract relative rotation between the flange and the rim base.

9. The method according to claim 8, comprising the step of shrink-fitting both the side flanges in position.

10. A method of manufacturing a multi-piece rim assembly for a pneumatic tire, which rim assembly comprises a substantially cylindrical rim base with opposite annular ends; a first side flange located against one of the annular edges; a second side flange located at the other annular edge; and an annular bead seat band located between the second side flange and the rim base,
comprising the step shrink-fitting the second flange around the bead seat band, thereby to counteract relative rotation movement between the second flange and the bead seat band.

11. The method according to claim 10, further comprising the step of shrink-fitting the first side flange onto the rim base, thereby to counteract relative rotational movement between the first side flange and the rim base.

12. A method of manufacturing a multi-piece rim assembly for a pneumatic tire, which rim assembly comprises a substantially cylindrical rim base with opposite annular ends; a first side flange located against one of the annular edges; a second side flange located at the other annular edge; and an annular bead seat band located between the second side flange and the rim base, comprising the step of shrink fitting the first flange onto the rim base, thereby to counteract relative rotational movement between the first side flange and the rim base.

13. A method of manufacturing a multi-piece rim assembly for a pneumatic tire, which rim assembly comprises a substantially cylindrical rim base having an annular end and a side flange located against the annular edge for containment of a tire mounted on the rim assembly, comprising the step of shrink fitting the side flange onto the rim base, thereby to counteract relative rotational movement between the side flange and the rim base.
